(19) United States
(12) Patent Application Publication
(10) Pub. No.: US 2008/0223151 A1
(43) Pub. Date: Sep. 18, 2008

(54) Static Torque Tester

(76) Inventor: Lou Lu Lai, Gurnee, IL (US)

Correspondence Address: COOK ALEX LTD, SUITE 2850, 200 WEST ADAMS STREET, CHICAGO, IL, 60606, US

(21) Appl. No.: 11/685,829

(22) Filed: Mar. 14, 2007

(51) Int. Cl. G01L 3/10

(52) U.S. Cl. 73/862.08

(57) ABSTRACT

A device and a method for measuring and indicating the static torque of a tapered roller bearing under varying axially applied loads. The device includes a base having a surface for supporting the cone of a tapered roller bearing, a fixture for engaging the cup of the tapered roller bearing when it is located on the base supporting surface. The fixture is mounted for linear movement with the cup relative to the cone to apply a static load to the cup. A variable static load applying mechanism such as an air cylinder is operatively connected to the fixture. A thrust applying frame which supports a thrust bearing connects the air cylinder and the fixture to uniformly transfer axial loads to the tapered roller bearing being tested. An indicating torque wrench is used to rotate the fixture and the engaged cup of the tapered roller bearing relative to the cone of the bearing under variable axial loads to determine and indicate the torque required. A lineal movement indicator is connected to the fixture to measure and indicate axial linear movement of the fixture and the engaged cup of the tapered roller bearing relative to the cone under various loads.

### BACKGROUND OF THE INVENTION

Tapered roller hearings are used in machines, equipment, vehicles of all types and in various components of vehicles, including components such as engines, transmissions, drive shafts, wheels, etc. When tapered roller bearings are installed in the foregoing machines, equipment and vehicles, they are generally installed where they are subjected to a load, usually an axial load. Under an axial load, the static torque, which is the force required to start rotation of the cone of a tapered roller bearing relative to its cup, is greater than the dynamic torque required to maintain the rotation of the cone relative to its cup after its initial start. If a relationship can be determined between the axial load applied to a tapered roller bearing, the static torque developed in the tapered roller bearing by this predetermined axial load and the amount of axial movement of the cup relative to the cone for each of the predetermined axial loads, a measurement of the relative axial movement between the cup and the cone will indicate the anticipated static torque of the tapered roller bearing. Measurement of the relative axial movement between the cup and the cone of a tapered roller bearing is usually easier to make than a measurement of its static torque.

### SUMMARY OF THE INVENTION

This invention is directed to a method of measuring the static torque of a tapered roller bearing under varying applied axial loads and a method of determining the amount of displacement of the cup of a tapered roller bearing relative to its cone under various applied axial loads. The invention further includes a device for easily and rapidly talking these measurements of tapered roller bearings under various axial loads.

An object of this invention is a method of applying an axial load of varying magnitude to the cup of a tapered roller bearing and measuring the static torque of the bearing and the relative axial movement of the bearing cup relative to its cone for each selected axial load.

Another object of this invention is an apparatus for applying variable axial loads to the cup of a tapered roller bearing which permits measurement of the static torque of the bearing and the relative axial movement of the bearing cup relative to its cone for each selected axial load.

Yet another object of this invention is an apparatus for measuring the static torque of a tapered roller bearing under a predetermined static axial load at three circumferential locations around the bearing.

### BRIEF DESCRIPTION OF THE DRAWINGS

The invention is shown more or less diagrammatically in the following drawings wherein:

FIG. 1 is a front elevational view of an embodiment of the apparatus of this invention with some portions cut away and others shown in cross section for clarity of illustration;

FIG. 2 is a side elevational view of the apparatus of FIG. 1;

FIG. 3 is an enlarged top plan view of the apparatus of FIG. 1 with some parts broken away and others shown in cross-section for clarity of illustration; and

FIG. 4 is an enlarged, underside view of the tapered roller hearing engaging fixture shown in FIGS. 1 and 2 of the drawings.

### DESCRIPTION OF THE PREFERRED EMBODIMENT

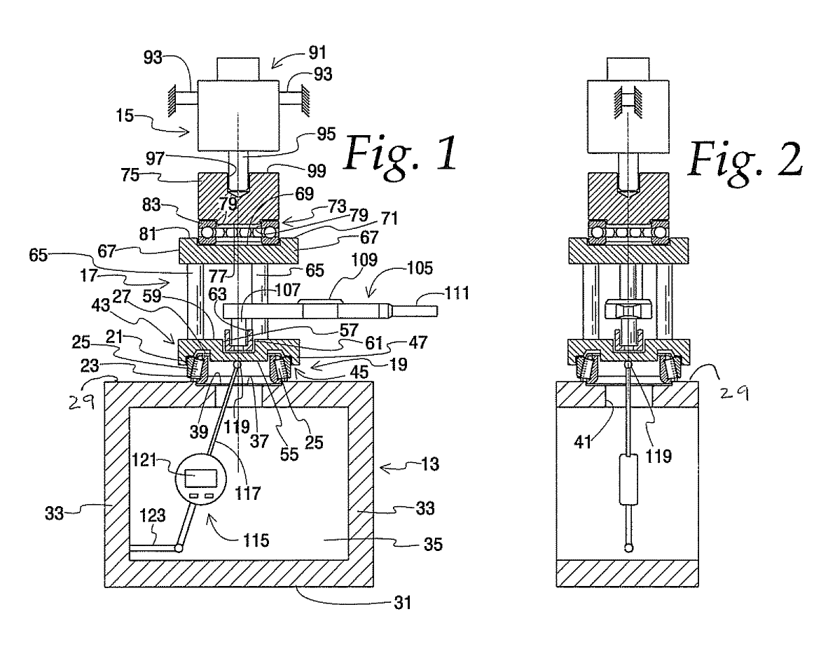

FIGS. 1 and 2 of the drawings show front and side elevational views of an embodiment of the static torque tester 11 of this invention. This static torque tester is used for measuring the static torque of tapered roller bearings. The static torque tester includes a base 13 for supporting a tapered roller hearing which is to be tested. A variable axial static load applying mechanism 15 applies a load to the cup of the bearing being tested and this axial load can be varied during the testing of a tapered roller bearing. A thrust applying frame 17 is located between the static force applying mechanism 15 and the base 13 is best shown in FIGS. 1 and 2 of the drawings. A tapered roller bearing 19 of the type which is to be tested includes a cup 21, a cone 23, tapered rollers 25 and a cage 27 which contains the tapered rollers.

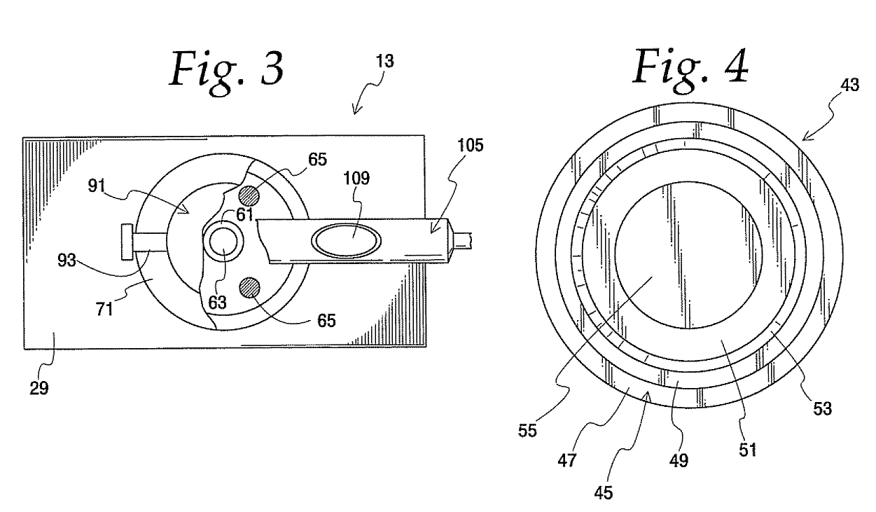

To measure the static torque of a tapered roller bearing 19, it is placed on the top wall 29 of the base. The base 13 also includes a bottom wall 31 having end walls 33 which walls collectively surround a cavity 33 with the base having open side walls. While supported on the base, the tapered roller bearing 19 is positioned in a recess 37 formed in the top wall 29 of the base. The recess has a bottom surface 39 which engages the cone 23 of the tapered roller bearing while not contacting the cone, tapered rollers or cage of the tapered roller bearing. A passage 41 extends through the recess of the top wall 29 into the cavity 35 of the base 13 as shown in FIGS. 2 and 3 of the drawings.

A disk shaped fixture 43 forms the base of the thrust applying frame 17 and is located above the top wall 29 of the base 13. The lower surface 45 of the fixture which faces the base 13 has an annular rim 47 for retaining the tapered roller bearing cup 21. The fixture also includes a recessed annular surface 49, shown most clearly in FIG. 4 of the drawing, which engages the end of the cup 21 of the tapered roller bearing 19 but does not contact the cone, tapered rollers or cage of the tapered roller bearing. Located radially inwardly of the recessed annular surface 49 is a deeper annular channel 51 sized to freely receive the cone, rollers and cage of the tapered roller bearing without exerting any axial load on these elements. The outer wall 53 of this channel which connects to the annular surface 49 is tapered. An annular circular portion 55 of the fixture located inwardly of the annular channel 51 extends in the direction of the base and into the cone of the tapered roller bearing.
A socket 57 of circular cross section is formed in the upper surface 59 of the fixture 43. A cylindrical plug 61 is press fitted into the socket 57 and is welded in place. A square cavity 63 is formed in the upper end of the cylindrical plug 61.

Three steel posts 65, each located 120° apart, are mounted on the upper surface of the fixture 43 and extend between the fixture and a top plate 67 of the frame 17. A circular socket 69 is formed in the upper surface 71 of the top plate of the thrust applying frame 17. The socket 69 is sized to receive a thrust bearing 73 seated in the socket. A cylindrical thrust block 75 rests on the thrust bearing 73 with the thrust block having a nose 77 of reduced diameter which fits into the inner diameter 79 of the thrust bearing. Shoulders 81 of the thrust block 75 engage a ring 83 of the thrust bearing to transfer the force of the thrust block evenly onto the thrust bearing 73 and the top plate 67 of the thrust applying frame 17.

The variable axial static load applying mechanism 15 includes an air cylinder 91 supported on mounting brackets 93. A piston rod 95 is retractable inwardly and outwardly of the air cylinder and seats in a piston socket 97 formed in the top of the thrust block 75. When the piston rod is retracted it moves out of the socket 97 of the thrust block and permits upper movement of the thrust block, the thrust applying frame 17 and its fixture 43, thus allowing the bearing 19 to be removed after testing and also permits the insertion of the next tapered roller bearing to be tested and measured.

A commercially available torque wrench 105 having a square drive stem 107 is shown in FIGS. 1, 2 and 3 of the drawings. The torque wrench includes a indicating read-out window 109 which is formed in the handle 111. The square drive stem is inserted into the square cavity 63 formed in the cylindrical plug at the top of the fixture 43. As can best be seen in FIG. 3 the torque wrench can be inserted into the square cavity of the fixture 43 in each of three circumferential positions between the steel posts 65 of the thrust applying frame to obtain three measurements of static torque for each tapered roller bearing being tested. Although a commercially available torque wrench provides the most economical and simple method of applying and determining the torque applied to the tapered roller bearing being tested, it should be understood and appreciated that other apparatus for applying and indicating the torque applied to the cup of the tapered roller bearing may be used.

The linear movement of the cup 21 of the tapered roller bearing 19 relative to the cone 23 thereof is measured by measuring the movement of the fixture 43 relative to the base (13). This is accomplished by the use of the digital measuring indicator 115. A suitable measuring indicator is manufactured by the Fred V. Fowler Company under the name Ultra Digit Mark V. Other suitable linear movement measuring indicators may be used. The digital measuring indicator 115 includes an elongated sensor rod 117 having a ball tip 119 that is held in contact with the under portion 55 of the fixture 43. An electronic read out indicator 121 is formed as part of the digital indicator and the digital indicator is supported by a shorter rod 123 pivotally connected to the elongated rod 117 with the shorter rod 123 being anchored in the wall 33 of the base 13.

The thrust applying frame 17 can be easily installed on and lifted off the tapered roller bearing 19 to institute a test and remove and replace the roller bearing after testing. Upon retraction of the piston rod 95 from the trust block 75, the thrust block, thrust bearing 73 and the thrust applying frame 17 may be lifted off the tapered roller bearing 19 and then reinstalled when another tapered roller bearing is positioned for test.

1. A device for measuring and indicating the static torque of a tapered roller bearing under varying axially applied loads, said device comprising:
a base having a surface for supporting the cone of a tapered roller bearing,
a fixture for engaging the cup of said tapered roller bearing located on said base supporting surface,
said fixture mounted for linear movement with said cup relative to said cone to apply a static load to said cup,
a variable static load applying mechanism operatively connected to said fixture, and
a socket formed in said fixture,
said socket shaped and sized to receive the stem of an indicating torque wrench to rotate said fixture and said engaged cup of said tapered roller bearing relative to said cone of said tapered roller bearing upon rotation of said indicating torque wrench.

2. The device of claim 1 including a linear movement indicator operatively connected to said fixture to measure and indicate axial linear movement of said fixture and said engaged cup of said tapered roller bearing relative to said cone.

3. The device of claim 1 including an indicating torque wrench having a stem shaped and sized to be removably inserted into said fixture socket.

4. The device of claim 1 in which said base surface supporting the cone of a tapered roller bearing is a recessed wall.

5. The device of claim 1 in which said fixture includes a recessed surface which engages the cup of tapered roller bearing.

6. The device of claim 1 in which said fixture includes a recessed channel to receive the cone, rollers and cage of the tapered roller bearing during engagement of the fixture with the cup of the tapered bearing.

7. The device of claim 1 in which said variable load applying mechanism operatively connected to said fixture includes a thrust applying frame associated with said fixture, a thrust bearing supported on said thrust applying frame, a thrust block engaging said thrust bearing with said thrust block engaged by said variable static load applying mechanism.

8. The device of claim 1 in which said variable static load applying mechanism is an air cylinder.

9. The device of claim 7 in which said fixture is disc shaped, said thrust applying frame includes three posts mounted on said fixture, with said post spaced 120° apart around said fixture to permit said indicating said torque wrench to be inserted in said socket of said fixture at locations around its periphery.

10. A device for measuring and indicating the static torque of a tapered roller bearing under varying axial applied loads, said device comprising:
a base having a surface for supporting the cone of a tapered roller bearing,
a fixture for engaging the cup of said tapered roller bearing located on said base supporting surface,
said fixture mounted for linear movement with said cup relative to said cone to apply a static load to said cup and not to said cone,
a variable static load applying mechanism operatively connected to said fixture, and
a torque applying and indicating mechanism to rotate said fixture and said engaged cup of said tapered roller bearing relative to said cone of said tapered roller bearing.

11. A method for measuring and indicating the static torque of a tapered roller bearing under varying axially applied static loads, said method comprising the steps of:
supporting the cone of a tapered roller bearing to permit axial movement of the cup of the bearing relative to its cone,
applying a variable static load to said cup of said tapered roller bearing to move said cup in an axial direction relative to said cone, and
measuring the static torque required to rotate said cup relative to said cone while under said applied static force.

12. The method of claim 11 further comprising the step of:
measuring the axial linear movement of said cup relative to said cone brought about by said applied static force.
